(19) United States
(12) Patent Application Publication
(10) Pub. No.: US 2004/0195834 A1
(43) Pub. Date: Oct. 7, 2004

(54) Fluid joint between fire equipment and connector

(76) Inventors: Robert W. Steingass, Valparaiso, IN (US); David J. Kolacz, Plymouth, IN (US)

Correspondence Address: LATHROP & CLARK LLP, 740 REGENT STREET SUITE 400, P.O. BOX 1507, MADISON, WI, 537011507

(21) Appl. No.: 10/406,883

(22) Filed: Apr. 4, 2003

(51) Int. Cl. F16L 39/00

(52) U.S. Cl. 285/321

(57) ABSTRACT

A fluid conduit joint that includes a male joint half and a female joint half that mate to define an annular groove, inside of which is disposed a bearing strip that secures the joint halves together, permits rotation of the couplings relative to one another, resists galvanic corrosion, and provides electrical insulating capabilities. The joint can also be configured to prevent rotation or to be secured at some desired orientation.

### FIELD AND BACKGROUND OF THE INVENTION

This invention relates generally to fluid conduit joints, and more specifically to a fluid conduit joint having a male joint half and a female joint half that together define an annular groove into which a bearing strip is inserted to prevent the male and female halves from separating. The male and female halves can be free to rotate relative to one another, free to rotate until a related connector is tightened, or locked to prevent rotation. The joint halves permit a variety of fire connectors to be interchangeably joined to a given valve, hose, or piece of fire equipment.

In the firefighting industry, various pieces of fire equipment such as pumps, hydrants, hoses, nozzles, monitors, and pipes are joined together with connectors. The connectors define internal waterways through which high-pressure firefighting fluids flow from one piece of equipment to another.

The mating connector halves of each connection engage one another using compatible threads or interlocking quick connections, or they can be connected in an androgynous manner. Threaded connectors are commonly defined in industry standards such as ANSI/ASME B20.7, ISO 228, or NFPA 1963, where a female thread mates with a male thread on adjoining pieces of fire equipment. Quick connections are described in various standards such as British Standard BS 336, which shows a spring-loaded pin in the female connector half that moves inward to engage an outwardly open channel in a mating male connector half.

The androgynous connections used in fire fighting within United States, Germany, Brazil and China are generally based on U.S. Pat. No. 481,107. Other types of connectors are popular in various other countries, but the wide variety of connector types can be a significant burden on equipment manufacturers.

Further complicating the manufacturer's responsibilities are whether the connectors swivel or are rotationally locked. To permit swiveling, many connectors are rotationally joined to the fire equipment using bearing balls or rollers mounted in raceways, or are fitted with a captive ring within the joint, which permanently joins the halves, or they may have an extra ring for swiveling built into the connector.

In addition to the various types of threaded, swivel, and locked connections that can be used, there are a variety of sizes of each type of connection. Sizes commonly vary from 1 inch to 6 inches in diameter.

Considering all of the various connector types and sizes, there can literally be hundreds of different combinations used to connect two pieces of fire equipment. To minimize the number of combinations to be used, individual fire departments typically select a single connector (“thread”) type for all of their fire equipment, but not all fire departments have selected the same type of thread. For example, New York firefighters have one type of thread while Chicago firefighters have another type of thread. These fire departments need not have threads that are compatible with one another because they do no fight fires together. Yet, within each fire department there is generally the convenience of a single connector type per size, so that all of its equipment is compatible.

This use of a single connector type results in a more convenient system for individual fire departments, but manufacturers of fire equipment must still produce fire equipment having inlets and outlets that have each type and size of connection thread required by their customers throughout the world. Thus, a manufacturer may need to make and inventory a single type of equipment with several different thread types built into the piece so that it can meet demand regardless of which fire department orders that piece of equipment.

Some manufacturers cut a fire connection directly into each port (opening) of the fire fighting equipment based on demand, and do not use a connecting joint on some their fire equipment. For example, when rotation of the connector relative to the piece of fire equipment is needed, a rotating joint is cut into and joined to the fire equipment. Typically a female hose thread coupling or at times an androgynous connector is joined to the rotary joint. However, when rotation of the connector is not desired and a variety of different connectors are needed on a given piece of fire equipment, then some manufacturers use threaded joints so that various non-rotating connectors can be joined to the fire equipment. This method is most prevalent for male hose threaded connectors, androgynous connectors, and quick connectors.

The threaded joint is sometimes used to join an intermediate adapter, which forms a secondary joint permitting rotation between the intermediate adapter and a connector such as a female threaded connector or an androgynous connector. The result of all these options is that manufacturers have had a high manufacturing cost and high inventory system for their fire equipment.

In addition to considerations regarding connector types and sizes, connections between dissimilar metals in the presence of a conductive liquid such as water causes galvanic corrosion. For example, this can occur with lightweight aluminum fire equipment being used on a fire engine with a cast iron pump intake. It is desirable for the fire equipment to be lightweight, but yet also resistant to the effects of galvanic corrosion. Galvanic corrosion can be reduced or prevented by insulating one coupling from another with some dielectric material. Given the variety of connections, and the high pressures used in fire fighting, it is impractical to make either the connectors or the fire equipment entirely from an insulating material such as plastic, so an insulating material is desired.

It is desirable to have a standard joint type that can be used in conjunction with each type of connector. The joint should be configured to either permit or prevent rotation as dictated by the type of connection desired. The joint should also permit a variety of connector sizes to be joined to a given piece of fire equipment. In addition, a joint that resists galvanic corrosion or that is electrically insulated is desirable.

### SUMMARY OF THE INVENTION

The present invention provides an interchangeable system for joining various pieces of fire equipment to a variety of fire connectors using mating male and female joint halves that form a strong joint capable of being configured in various types, such as swiveling, swiveling until tightened or being locked from rotation. The various configurations can be made without the use of intermediate adapters. The invention reduces the number of different component parts needed to manufacture fire equipment and allows fire equipment to be modified in the field to virtually any desired connection type.

The invention can include a series of intermediate adapters that can enlarge or reduce the size of the joint, thereby allowing connectors of virtually any size to be joined to the fire equipment. The invention can also include intermediate adapters having double male or double female joint halves in identical or differing sizes, which are useful for joining two or more pieces of fire equipment together to form combinations that were heretofore impractical. Further, the invention can be electrically insulated to provide resistance to galvanic corrosion.

The present invention includes a fluid conduit joint having a male joint half defining a radially outwardly open channel, and a female joint half defining a radially inwardly open channel. The female joint half mates with the male joint half to position where the respective channels are adjacent to one another to define an annular groove. A bearing strip is then disposed in the annular groove to prevent the two halves from separating.

The joint can be configured as a swivel type of joint or a key may be used to rotationally lock the male and female joint halves relative to one another. In another embodiment, the joint may swivel until tightened to another piece of equipment. This type of connector is desirable because it allows the rotational position of the fire equipment to be set in a desired orientation when tightened.

The fluid conduit joint also includes a tangential hole extending from the annular groove to an external port through which a flexible bearing strip can be installed into the annular groove and the male and female connector halves have been assembled. The bearing strip can include a hook at its tail end so that a tool can be inserted through the tangential hole to engage the hook, remove the bearing strip, and disassemble the joint when desired.

The bearing strip need not completely fill the circumference of the annular groove. Instead, the ends of the bearing strip or multiple shorter bearing strips can be spaced apart resulting in only a portion of the annular groove being filled by the bearing strip.

Preferably, the annular groove and the bearing strip have substantially similar cross-sectional shapes to more efficiently transfer load from one connector half to the other. Further, by making the bearing strip cross-sectional area large enough, the male and female connector halves are less likely to contact one another and create a spaced relationship that can reduce corrosion and provide electrical insulation between the two joint halves. The bearing strip is preferably made of nylon, to provide necessary shear strength, flexibility, toughness, and corrosion resistance necessary for firefighting equipment.

The cross-sectional shapes of the annular groove and the bearing strip are preferably diamond-shaped to efficiently transfer the force due to water pressure from one joint half to another. The root (low portions) of the open channels are preferably rounded to reduce stress concentrations.

When configured to swivel, the joint rotates freely when mated to another piece of fire equipment such as a hose. Swiveling joints can be useful to release twists in a hose as it is charged thereby avoiding undesired kinks. Swiveling joints also allow elbow fittings to be easily oriented to avoid interference with adjacent equipment. Swiveling joints also allow a mating fire hose to achieve the most advantageous angle relative to the equipment upstream and downstream from the joint thereby reducing entrance kinks and stress on a hose or allowing the fire hose to be optimally positioned relative to various obstacles. Frictional forces in swiveling joints increase proportionally with pressure so that during setup the joint swivels freely, but at high pressure the joint may swivel less or not at all. Swiveling is typically not needed at high pressures given the relative immobility of a charged fire hose.

When it is desired to prevent rotation of the joint, a key-way can be formed between male and female joint halves and a key inserted to rotationally lock the joint together.

The bearing strip can be any length and a number of relatively short bearing strips can be used in place of one or more longer bearing strips. The bearing strip should complete at least 270° of the circumference of the annular groove to ensure sufficient bearing surface between the bearing strip and the joint halves.

It is generally preferable to mount the male joint halves on the piece of fire equipment and to mount the female joint halves on the connectors. However, joints of the opposite gender might be preferable on some fire equipment, or connectors according to design considerations or market demand.

These and other benefits of the invention will be apparent from the detailed description below.

### BRIEF DESCRIPTION OF THE DRAWINGS

FIG. 1 is an exploded perspective view of a joint in accordance with the present invention;

FIG. 2 is a cross-sectional view of a swiveling joint in accordance with the present invention taken along line 2-2 in FIG. 9a;

FIG. 3 is a cross-sectional view of a non-swiveling joint in accordance with the present invention;

FIG. 4 is a cross-sectional view of a joint that swivels until its related connector is tightened, in accordance with the present invention;

FIG. 5 is a cross-sectional view of a connector adaptor in accordance with the present invention;

FIG. 6 is a partial cross-sectional view of a joint and key-way in accordance with the present invention;

FIG. 7 is a plan view of a bearing strip in accordance with the present invention;

FIG. 8 is a plan view of a female connector half in accordance with the present invention;

FIG. 9a is a side view of an assembled joint in accordance with the present invention;

FIG. 9b is an end view of the assembled joint taken along line 9b-9b in FIG. 9a.

### DESCRIPTION OF THE PREFERRED EMBODIMENTS

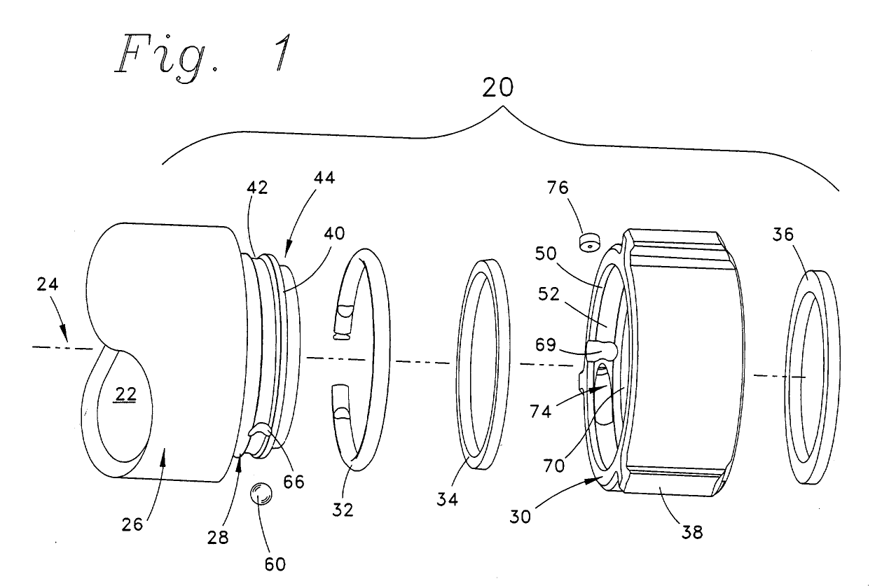

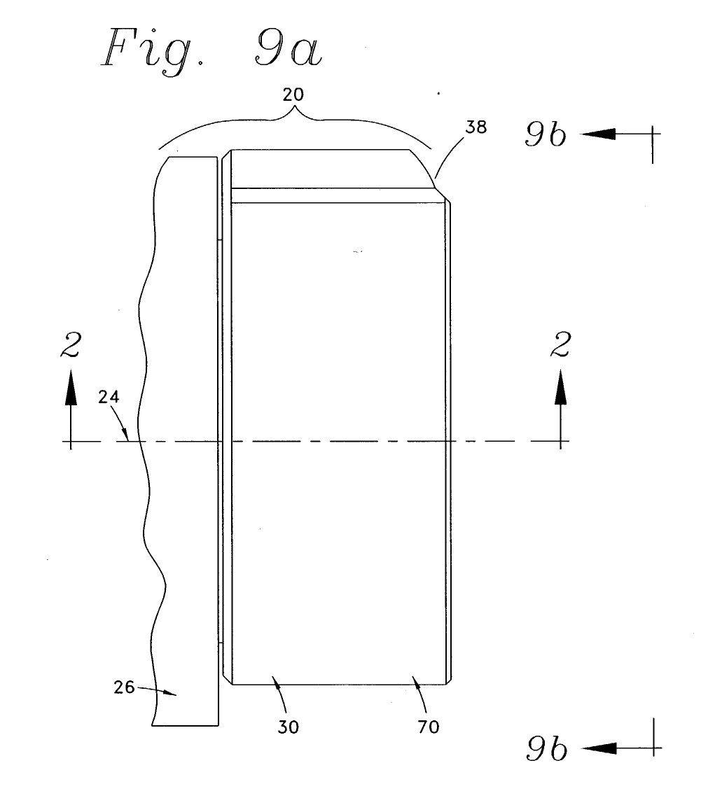

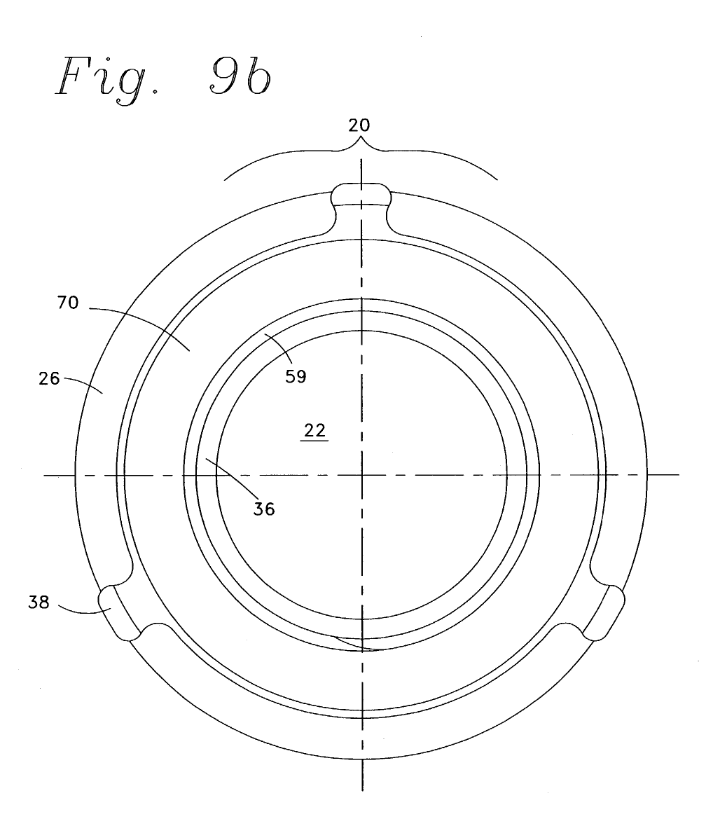

In the following detailed description of drawings, the same reference numeral will be used to identify the same element in each of the figures. Referring to FIGS. 1, 2, 9a, and 9b there is depicted a joint 20 in accordance with the present invention. The joint 20 defines a central conduit 22 having a central axis 24 about which the joint 20 is cylindrical. The joint 20 could be used with any fluid that can flow through the conduit 22, particularly for high flow conditions that require the joint 20 to be adaptable to a number of different coupling threads. Such a joint 20 is suitable for use in fire equipment to join connectors, which mate to adjacent pieces of fire equipment.

The joint 20 includes a port 26, a male joint half 28, a female joint half 30, a bearing strip 32, a seal 34, a gasket 36, and a lug 38. The port 26 can be manufactured as integral as part of any type of fire equipment such as pumps, hydrants, hoses, pipes, nozzles, and monitors. All of these pieces of fire equipment must be joined to an adjacent piece of fire equipment to form a continuous conduit from a firefighting fluid source to the tip of a nozzle (not depicted) that directs firefighting fluid toward a fire or other hazard. Firefighting fluids include water, foam concentrate, foam, and others that are generally at high pressure while in the waterway 22.

It is noted that port 26 could be an inlet or an outlet. There is no distinction between the two for purposes of describing the invention, how it operates, or is manufactured.

Preferably, the port 26 includes the male joint half 28, although a female joint half 30 could be joined to the port 26. The male joint half 28 defines the central conduit 22 and typically has a generally smooth cylindrical outer surface 40. In the outer surface 40 there is defined a radially outwardly open channel 42.

The outward open channel 42 can have any cross-sectional shape, but a generally v-shaped channel as depicted is preferred. The channel 42 can be machined into the male joint half 28 or formed into it when it is cast. Typically, the male joint half 28 will be made of cast or wrought aluminum, but other materials can be used as well.

At the extreme distal end of the male joint half 28, there is an annular recess 44 into which the seal 34 is disposed. The seal 34 has a generally v-shaped cross-section to permit substantial resiliency and compression of the seal 34 for a fluid-tight connection. A suitable seal 34 is made of nitrile rubber of 80 durometer on scale Shore A, or available as Buna-N Compound No. 3847, available from Precision Associates Inc. of Minneapolis Minn.

The female joint half 30 is generally cylindrical about the central axis 24 of the waterway 22. On its inner surface 50, there is machined or cast a radially inwardly open channel 52 that opposes the radially outwardly open channel 42 of the male joint half 28 to define an annular groove 54 when the two joint halves are assembled. The inwardly open channel 52 can be any shape in cross-section, but it preferably has the same shape as the outwardly open channel 42 of the male joint half 28. In the illustrated example, the channels 42 and 52 are generally v-shaped, which makes the resulting annular groove 54 generally diamond-shaped. As viewed in FIG. 1, female joint half 30 also includes a tangential hole 74 and a hole cover 76.

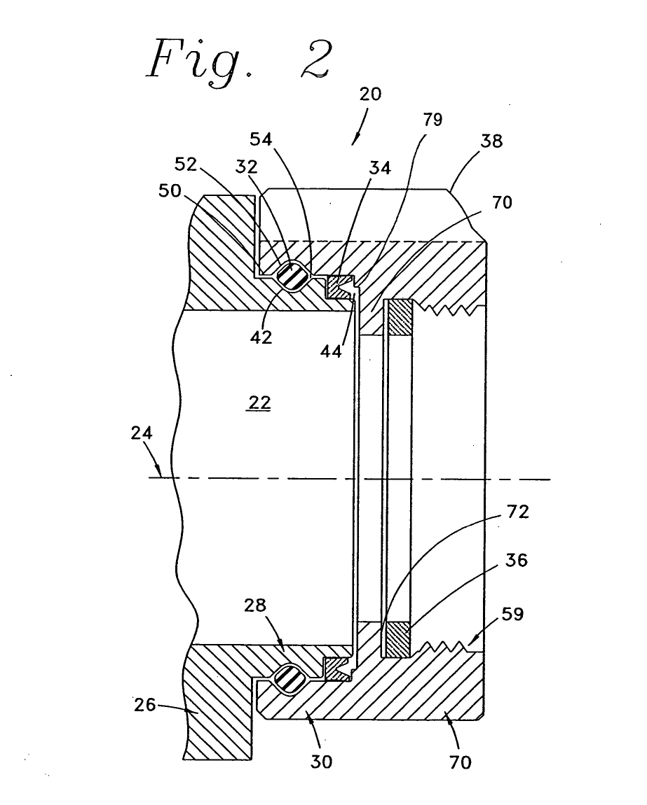

The female joint half 30 of FIGS. 1 and 2 includes an inwardly extending radial wall 70 that is broad enough to engage the seal 34, but narrow enough to avoid interference with the waterway 22. The wall may include a slight step 77 (see: FIG. 2) to further improve contact with seal 34.

The female joint half 30 also includes a fire connector 70 which is depicted in FIG. 2 as a female threaded connector 59, but it could be made as male threads, one half of a quick connector, or as an androgynous connector. Any number of female joint halves 30 can be manufactured with all types of connectors, threads, or sizes and inventoried so that the resulting joint 20 can be quickly made to accommodate any connector specified by a customer. This reduces the need to make and inventory equipment with standard threaded connectors built integrally into the equipment.

Female threaded connectors 59 generally have a gasket 36 that rests against the radial wall 56 to provide a watertight seal when the female threads 59 are connected to a mating piece of fire equipment.

Extending outwardly from the female joint half 30 is a lug 38 that is used to tighten the threads 59 to a mating connector piece (not illustrated). The lug 38 may be capable of hand tightening or it may be tightened by a tool such as a spanner wrench.

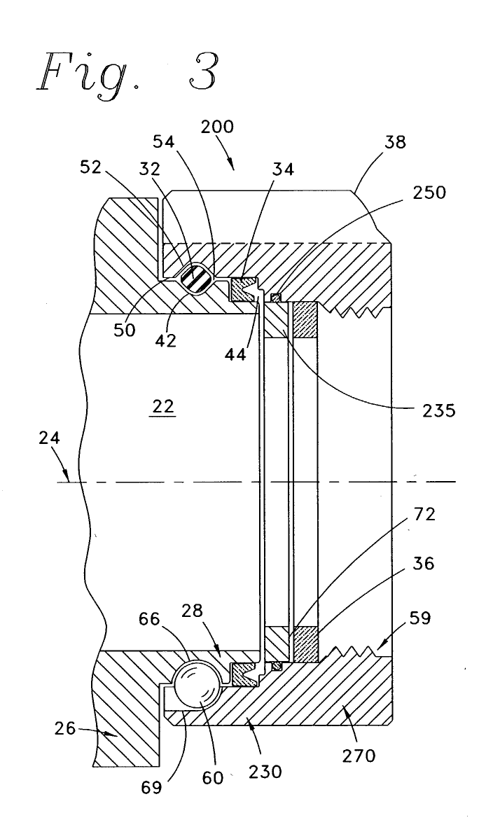

The joint 20 depicted in FIGS. 1, 2, 9a, and 9b is designed to permit swiveling of the female joint half 30 relative to the male joint half 28, but a locking key 60 (FIGS. 1 and 3) can be inserted into a mating recess 66 to prevent swiveling as described more fully below.

FIG. 3 depicts a cross-section of a joint 200 that is prevented from swiveling by the locking key 60. The female joint half 230 is nearly the same the same as that depicted in FIG. 2 except that the female connector half is labeled 270. In this embodiment, a push ring 235 is used to restrain the rotational position of the joint 200 to a set position when female threaded connector 270 is tightened down against the threads of a related piece of equipment. A push ring 235 in this device is essentially an aluminum washer that establishes a friction fit as the threads are tightened down during assembly of the connector threads 59.

An O-ring 250 prevents leakage around the push ring 235. Rotation of joint 200 is shown configured as locked because a locking key 60 in the form of a ball mutually engages both the keyway 66 and a slot 69 in the female connector half 230. Omission of the key ball 60 configures the joint 200 in a swiveling manner, as in FIG. 2, but the push ring 235, can be used to prevent swiveling after a related piece of equipment is threaded into the female threaded connector 59.

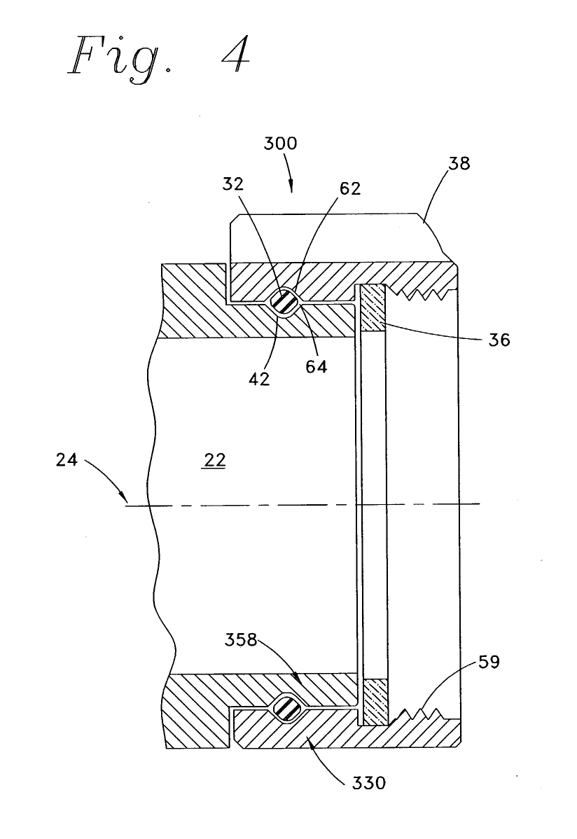

FIG. 4 depicts a cross-section of a joint 300 that can also be tightened down on the threads 59 to fix the joint 200 in a desired orientation, but there is no locking key as was used in the FIG. 3 embodiment. The male joint half 358 is nearly the same as that depicted in FIGS. 1, 2, and 3 except that there is no annular recess or seal at the distal end of the connector half. The female joint half 330 has an inwardly open channel 62 that mates with the outwardly open channel 42 of the male joint half 358 to define an annular groove 64, but there is no radial wall for a seal. Instead, there is simply a gasket 36 that bears on the end of the male connector half 358. The threads 59 and lug 38 are essentially as described above in reference to FIG. 2.

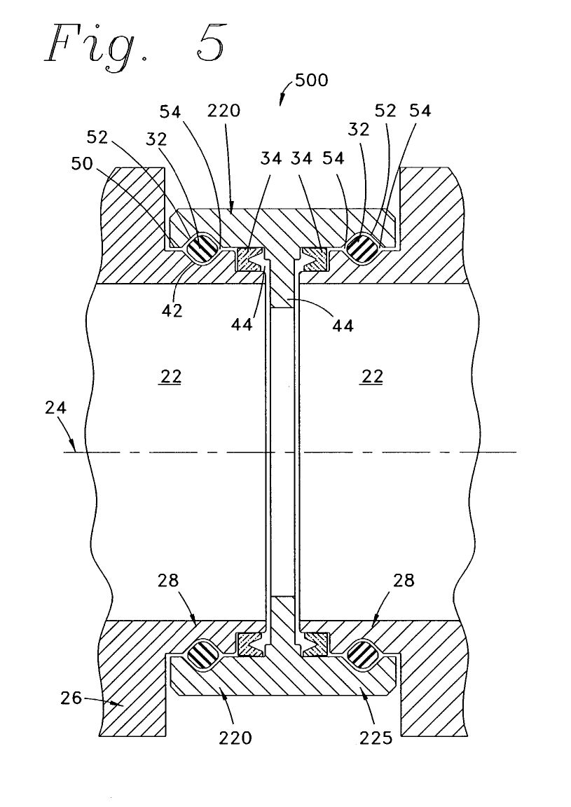

In FIG. 5 the female joint half 220 includes a second joint half 225 which is depicted as a female joint half 225 of identical size to define a double-female swivel adaptor 500. This is useful for joining pieces of fire equipment with male joint halves 28 together with a swiveling joint as in the case of an elbow joined to a valve. Second joint half 225 could also be a larger or smaller size, or made in the opposite gender, in the same way double female joint halves of identical or differing sizes could also be made.

All of the joints 20, 200, 300, and 500 include a bearing strip 32 disposed in the annular grooves 54. (FIGS. 2, 3, 4, and 5) The bearing strip 32 preferably has a shape that is generally the same as the annular groove. In the depicted examples, the bearing strip 32 is generally diamond-shaped in cross-section.

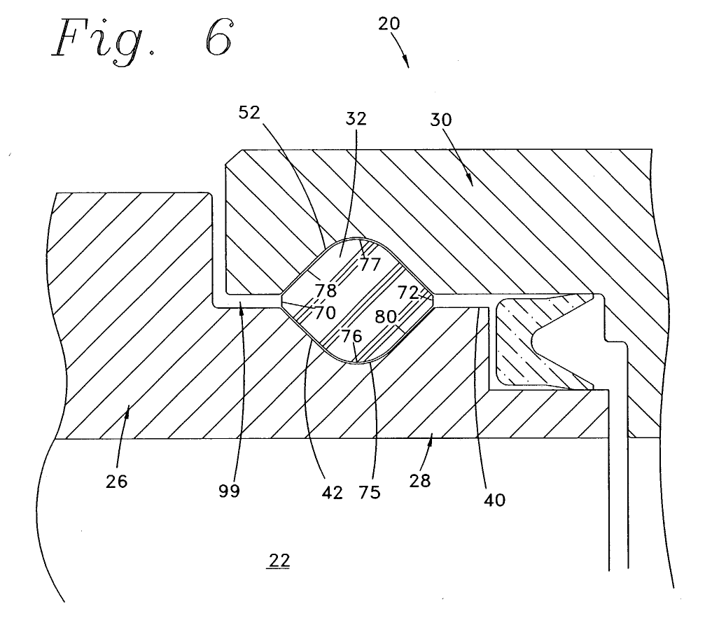

In FIG. 6, the cross-section of the bearing strip 32 and channels 42, 62 are enlarged to depict more clearly how the preferred cross-section of bearing strip 32 is sized relative to the cross-section of the annular channels 42 and 52, so that the bearing strip 32 effectively prevents contact between the two joint halves. By maintaining a clearance 99 between the two joint halves and manufacturing the bearing strip 32 out of a dielectric material such as nylon, there is a reduction in galvanic corrosion and electrical conductivity through the joint 20, 200, 220 and 300, and double female swivel adaptor 500. This increases the effective life of the joint.

By using the preferred diamond-shaped cross-section for the bearing strip 32, an efficient transfer of axial loads is accomplished. High-pressure fluids in the waterway 22 tend to force mating connector halves apart. To resist these forces, which are particularly high in fire equipment, the bearing strip 32 must have sufficient shear and bearing capacity, and it must be able to transfer the load from one coupling to the other.

The preferred bearing strip 32 is made of DuPont Zytel® nylon grade 101L BKB009 available from Ashland Distribution Co., in Dublin, Ohio, and has a dimension of 0.291+/−0.002 of an inch between flank 78 and flank 80. The opposite two flanks are similarly dimensioned. The bearing strip 32 also preferably has flattened corners 70, 72, which measure about 0.07 of an inch. This is allows the tangential hole 74 to be kept to a minimal size. The annular channels 42 and 52 are preferably machined in aluminum and have their roots 75 rounded to an eighth of an inch radius to reduce stress concentrations. Rounded crests 76 and 77 of the bearing strip 32 are made to a corresponding size. This combination of dimensions allows the bearing strip 32 to maintain clearance 99 of about 0.035 inch per side between the male joint half 28 and the female joint half 30.

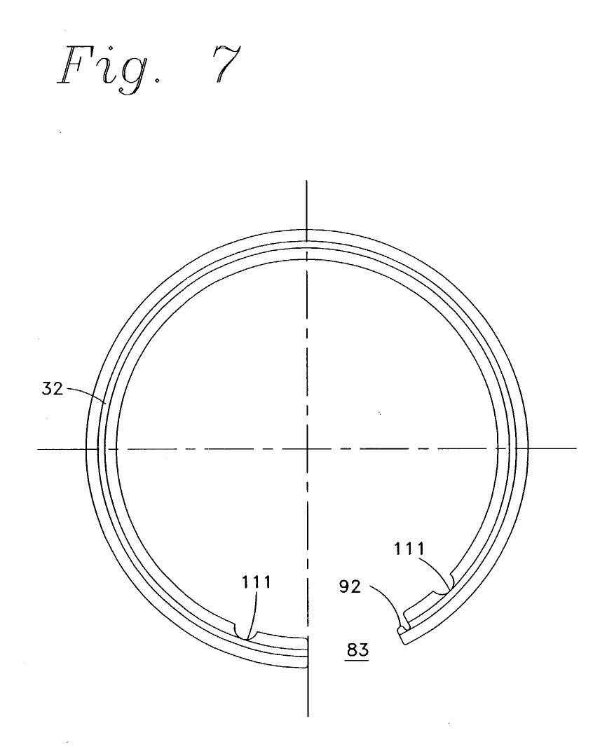

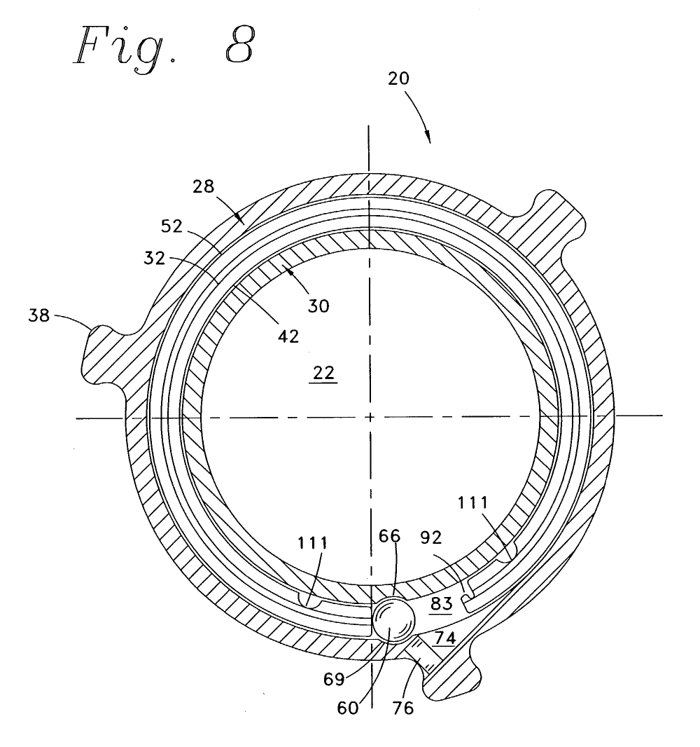

Depicted in FIGS. 7 and 8 are a plan view of the bearing strip 32 above (FIG. 7) and a bearing strip 32 disposed in a female connector half 28 (FIG. 8). As illustrated, the bearing strip 32 can be seen to fill a substantial portion of the annular groove 54, but the bearing strip 32 preferably does not form a complete ring. It is not necessary for the strength of the joint, and it provides a convenient way to assemble and disassemble the joint.

To assemble the joints described herein, the male and female connector halves are assembled and the bearing strip 32 is fed through the tangential hole 74 that extends from the annular groove 52. The bearing strip 32 is flexible enough to be fed through the relatively straight tangential hole 74 and regain its shape as it moves through the annular groove 52 by virtue of being made from a flexible material. Another example of a flexible bearing strip 32 is one using one or more cutouts 111 that reduce localized cross-sectional area of the bearing strip 32 to provide flex points that act as “living hinges.” Once installed, the bearing strip 32 preferably defines a gap 83 between its ends of about 26 degrees, but other gap dimensions up to and including 90° are sufficient to maintain the two connector halves together. It is also possible to use a multi-piece bearing strip, if desired. When multiple bearing strips are used, the total gap dimension between bearing strips can equal 90° or less.

The bearing strip 32 is illustrated as a simple strip that is installed through the tangential hole 74, but other embodiments are possible and within the scope of the present invention. For example, the strip could be “injection molded” by injecting plastic through a hole and allowing it to solidify in place. Small segments of a bearing strip could be inserted through a rectangular hole one at a time until a desired number are positioned in the annular groove 52.

The assembly of the joint takes place at the manufacturing facility after a given piece of fire equipment has been ordered and a connector type and size is specified. The piece of fire equipment is pulled from inventory, as is a joint half with the specified connector type. The joint halves are then assembled and the bearing strip installed. Once the joint is assembled, it is only necessary for the end-user to operate the connector in the same manner as previously known. Thus, the joint does not affect the end-user's operation of the equipment, but the manufacturer has reduced the inventory requirements for that piece of equipment.

To disassemble the joint, a tool with a hook (not depicted) is fed through the tangential groove 86 to engage a hook 92 in one end of the bearing strip 32. The tool can thus be used to pull the bearing strip 32 out of the annular groove 52 to permit the male and female couplings to be disassembled. Disassembly may be necessary for repair, maintenance, or even to change the connector type on a given piece of fire equipment.

As indicated above, the joint 200 of FIG. 3 is not intended to swivel. The male joint half 28 includes a key 66 into which key ball 60 preferably made of annealed type 303 stainless steel can be inserted to engage a slot 69 in the female joint half 230 and occupy a portion of the gap 83 in bearing strip 32. This prevents the female joint half 230 from swiveling relative to the bearing strip 32 and the male joint half 28. Although depicted as including a key ball 60, the key 66 can be any suitable shape and configuration of components. In a similar way, this method can be used on any other joint in accordance with the present invention.

The foregoing detailed description of the drawings is intended for clearness of understanding of the invention, and no unnecessary limitations therefrom should be read into the following claims.

1. A fluid conduit joint, comprising:
a male joint half defining a radially outwardly open channel;
a female joint half defining a radially inwardly open channel, the female joint half to mate with the male joint half and define an annular groove when the radially outward open channel is disposed adjacent to the radially inward open channel; and
a removable bearing strip disposed in the annular groove to insulate the male joint half from the female joint half, the bearing strip having a first end and a second end.

2. The fluid conduit joint of claim 1, wherein the female joint half further defines a tangential groove extending from the annular groove to an external port, whereby the bearing strip can be installed in the annular groove through the tangential groove.

3. The fluid conduit joint of claim 2, wherein the bearing strip second end comprises a hook, whereby the hook can be engaged by a tool to enable removal of the bearing strip from the annular groove through the tangential groove.

4. The fluid conduit joint of claim 1, wherein the bearing strip first end and second end are spaced apart when the bearing strip is disposed in the annular groove.

5. The fluid conduit joint of claim 1, wherein the bearing strip first end and second end are spaced apart about 90° or less when the bearing strip is completely disposed in the annular space.

6. The fluid conduit joint of claim 1, wherein the bearing strip and the annular groove have substantially similar cross-sectional shapes.

7. The fluid conduit joint of claim 1, wherein the bearing strip is sized to maintain a space between the male joint half and the female joint half.

8. The fluid conduit joint of claim 1, wherein the male and female joint halves further cooperate to define a second annular groove, and the rotatable fluid conduit joint further comprises a seal disposed in the second annular groove.

9. The fluid conduit joint of claim 1, wherein the bearing strip is manufactured from nylon.

10. The fluid conduit joint of claim 1, wherein the bearing strip and the annular groove each have a substantially diamond-shaped cross-section.

11. (Canceled)

12. The fluid conduit joint of claim 1, wherein the female joint half includes a second female joint half adapted to mate with a second male joint half.

13. (Canceled)

14. The fluid conduit joint of claim 1, and further comprising a second bearing strip disposed in the annular groove.

15. The fluid conduit joint of claim 1 wherein the male joint half and the female joint half are free to rotate relative to one another.

16. A firefighting equipment port having joined thereto a fluid conduit joint, the fluid conduit joint comprising:
a male joint half joined to the firefighting equipment port and defining a radially outwardly open channel;
a female joint half defining a radially inwardly open channel, the female joint half to mate with the male joint half and define an annular groove when the radially outward open channel is disposed adjacent to the radially inward channel; and
a removable bearing strip disposed in the annular groove to insulate the male joint half from the female joint half, the bearing strip having a first end and a second end.

17. The firefighting equipment port of claim 16, wherein the female joint half further defines a tangential groove extending from the annular groove to an external port, whereby the bearing strip can be installed in the annular groove through the tangential groove.

18. The firefighting equipment port of claim 17, wherein the bearing strip second end comprises a hook, whereby the hook can be engaged by a tool to enable removal of the bearing strip from the annular groove through the tangential groove.

19. The firefighting equipment port of claim 16, wherein the bearing strip first end and second end are spaced apart when the bearing strip is disposed in the annular groove.

20. The firefighting equipment port of claim 16, wherein the bearing strip first end and second end are spaced apart about 90° or less when the bearing strip is completely disposed in the annular space.

21. The firefighting equipment port of claim 16, wherein the bearing strip and the annular groove have substantially similar cross-sectional shapes.

22. The firefighting equipment port of claim 16, wherein the bearing strip is sized to maintain a space between the male joint half and the female joint half.

23. The firefighting equipment port of claim 16, wherein the male and female joint halves further cooperate to define a second annular groove, and the rotatable fluid conduit joint further comprises a seal disposed in the second annular groove.

24. The firefighting equipment port of claim 16, wherein the bearing strip is manufactured from nylon.

25. The firefighting equipment port of claim 16, wherein the bearing strip and the annular groove each have a substantially diamond-shaped cross-section.

26. (Canceled)

27. The firefighting equipment port of claim 16, wherein the female joint half is joined to a firefighting equipment connector.

28. (Canceled)

29. The firefighting equipment port of claim 16, and further comprising a second bearing strip disposed in the annular groove.

30. The firefighting equipment port of claim 16, wherein the male joint half and the female joint half are free to rotate relative to one another.

31. A fluid conduit joint adapter, comprising:
a pair of female joint halves each defining a radially inwardly open channel, the female joint halves each being adapted to mate with a male joint half and define an annular groove when the radially inward open channel is disposed adjacent to a radially outward channel in a corresponding male joint half wherein the female joint halves further define a tangential groove extending from the annular groove to an external port whereby the bearing strip can be installed in the annular groove through the tangential groove; and
a removable bearing strip disposed in each annular groove, the bearing strip having a first end and a second end.

32. (Canceled)

33. (Canceled)

34. The fluid conduit joint adapter of claim 31, wherein the bearing strip first end and second end are spaced apart when the bearing strip is disposed in the annular groove.

35. The fluid conduit joint adapter of claim 31 wherein the bearing strip first end and second end are spaced apart about 90° or less when the bearing strip is completely disposed in the annular space.

36. The fluid conduit joint adapter of claim 31, wherein the bearing strip and the annular groove have substantially similar cross-sectional shapes.

37. The fluid conduit joint adapter of claim 31, wherein the bearing strip is sized to maintain a space between the male joint half and the female joint half.

38. The fluid conduit joint adapter of claim 31, wherein the male and female joint halves further cooperate to define a second annular groove, and the rotatable fluid conduit joint further comprises a seal disposed in the second annular groove.

39. The fluid conduit joint adapter of claim 31, wherein the bearing strip is manufactured from nylon.

40. The fluid conduit joint adapter of claim 31, wherein the bearing strip and the annular groove each have a substantially diamond-shaped cross-section.

41. (Canceled)

42. The fluid conduit joint adapter of claim 31, wherein the female joint halves extend in substantially opposite directions from one another.

43. (Canceled)

44. The fluid conduit joint adapter of claim 31, and further comprising a second bearing strip disposed in the annular groove.

45. The fluid conduit joint adapter of claim 31, wherein the male joint half and the female joint half are free to rotate relative to one another.

46. A fluid conduit joint, comprising:
a male joint half defining a radially outwardly open channel;
a female joint half defining a radially inwardly open channel, the female joint half to mate with the male joint half and define an annular groove when the radially outward open channel is disposed adjacent to the radially inward open channel; and
a removable bearing strip disposed in the annular groove, the bearing strip having a first end and a second end, wherein the bearing strip has substantially diamond-shaped cross-section, and has lateral corners that are rounded to relieve stress concentrations.

47. The fluid conduit joint of claim 46, wherein the female joint half further defines a tangential groove extending from the annular groove to an external port, whereby the bearing strip can be installed in the annular groove through the tangential groove.

48. The fluid conduit joint of claim 47, wherein the bearing strip second end comprises a hook, whereby the hook can be engaged by a tool to enable removal of the bearing strip from the annular groove through the tangential groove.

49. The fluid conduit joint of claim 46, wherein the bearing strip is sized to maintain a space between the male joint half and the female joint half.

50. The fluid conduit joint of claim 46, wherein the male and female joint halves further cooperate to define a second annular groove, and the rotatable fluid conduit joint further comprises a seal disposed in the second annular groove.

51. The fluid conduit joint of claim 46, wherein the bearing strip and the annular groove each have a substantially diamond-shaped cross-section.

52. The fluid conduit joint of claim 46, wherein the female joint half further defines a key-way and the joint further comprises a key disposed in the key-way to resist rotation of the male joint half relative to the female joint half.

53. The fluid conduit joint of claim 46, wherein the male joint half and the female joint half are free to rotate relative to one another.

54. A firefighting equipment port having joined thereto a fluid conduit joint, the fluid conduit joint comprising:
a male joint half joined to the firefighting equipment port and defining a radially outwardly open channel;
a female joint half defining a radially inwardly open channel, the female joint half to mate with the male joint half and define an annular groove when the radially outward open channel is disposed adjacent to the radially inward channel; and
a removable bearing strip disposed in the annular groove, the bearing strip having a first end and a second end, wherein the bearing strip has substantially diamond-shaped cross-section, and has lateral corners that are rounded to relieve stress concentrations.

55. The firefighting equipment port of claim 54, wherein the female joint half further defines a tangential groove extending from the annular groove to an external port, whereby the bearing strip can be installed in the annular groove through the tangential groove.

56. The firefighting equipment port of claim 55, wherein the bearing strip second end comprises a hook, whereby the hook can be engaged by a tool to enable removal of the bearing strip from the annular groove through the tangential groove.

57. The firefighting equipment port of claim 54, wherein the bearing strip is sized to maintain a space between the male joint half and the female joint half.

58. The firefighting equipment port of claim 54, wherein the male and female joint halves further cooperate to define a second annular groove, and the rotatable fluid conduit joint further comprises a seal disposed in the second annular groove.

59. The firefighting equipment port of claim 54, wherein the bearing strip and the annular groove each have a substantially diamond-shaped cross-section.

60. The firefighting equipment port of claim 54, wherein the female joint half is joined to a firefighting equipment connector.

61. The firefighting equipment port of claim 54, wherein the male joint half further defines a key-way and the joint further comprises a key disposed in the key-way to resist rotation of the male joint half relative to the female joint half strip.

62. The firefighting equipment port of claim 54, wherein the male joint half and the female joint half are free to rotate relative to one another.

63. A fluid conduit joint adapter, comprising:
a pair of female joint halves each defining a radially inwardly open channel, the female joint halves each being adapted to mate with a male joint half and define an annular groove when the radially inward open channel is disposed adjacent to a radially outward channel in a corresponding male joint half;
a removable bearing strip disposed in each annular groove, the bearing strip having a first end and a second end; and
wherein at least one of the female joint halves further defines a tangential groove extending from the annular groove to an external port, whereby the bearing strip can be installed in the annular groove through the tangential groove.

64. The fluid conduit joint adapter of claim 63, wherein the bearing strip is sized to maintain a space between the male joint half and the female joint half.

65. The fluid conduit joint adapter of claim 63, wherein the male and female joint halves further cooperate to define a second annular groove, and the rotatable fluid conduit joint further comprises a seal disposed in the second annular groove.

66. The fluid conduit joint adapter of claim 63, wherein the bearing strip and the annular groove each have a substantially diamond-shaped cross-section.

67. The fluid conduit joint adapter of claim 63, wherein the bearing strip has substantially diamond-shaped cross-section, and has lateral corners that are rounded to relieve stress concentrations.

68. The fluid conduit joint adapter of claim 63, wherein the female joint halves extend in substantially opposite directions from one another.

69. The fluid conduit joint adapter of claim 63, wherein the male joint half further defines a key-way and the joint further comprises a key disposed in the key-way to resist rotation of the male joint half relative to the female joint half strip.

70. The fluid conduit joint adapter of claim 63, wherein the male joint half and the female joint half are free to rotate relative to one another.

71. A fluid conduit joint, comprising:
a male joint half defining a radially outwardly open channel;
a female joint half defining a radially inwardly open channel, the female joint half to mate with the male joint half and define an annular groove when the radially outward open channel is disposed adjacent to the radially inward open channel, wherein the female joint half further defines a key-way and the joint further comprises a key disposed in the key-way to resist rotation of the male joint half relative to the female joint half; and
a removable bearing strip disposed in the annular groove, the bearing strip having a first end and a second end.

72. The fluid conduit joint of claim 71, wherein the female joint half further defines a tangential groove extending from the annular groove to an external port, whereby the bearing strip can be installed in the annular groove through the tangential groove.

73. The fluid conduit joint of claim 72, wherein the bearing strip second end comprises a hook, whereby the hook can be engaged by a tool to enable removal of the bearing strip from the annular groove through the tangential groove.

74. The fluid conduit joint of claim 71, wherein the bearing strip is sized to maintain a space between the male joint half and the female joint half.

75. The fluid conduit joint of claim 71, wherein the male and female joint halves further cooperate to define a second annular groove, and the rotatable fluid conduit joint further comprises a seal disposed in the second annular groove.

76. The fluid conduit joint of claim 71, wherein the bearing strip and the annular groove each have a substantially diamond-shaped cross-section.

77. The fluid conduit joint of claim 71, wherein the bearing strip has substantially diamond-shaped cross-section, and has lateral corners that are rounded to relieve stress concentrations.

78. The fluid conduit joint of claim 71, wherein the male joint half and the female joint half are free to rotate relative to one another.

79. A firefighting equipment port having joined thereto a fluid conduit joint, the fluid conduit joint comprising:
a male joint half joined to the firefighting equipment port and defining a radially outwardly open channel;
a female joint half defining a radially inwardly open channel, the female joint half to mate with the male joint half and define an annular groove when the radially outward open channel is disposed adjacent to the radially inward channel, wherein the male joint half further defines a key-way and the joint further comprises a key disposed in the key-way to resist rotation of the male joint half relative to the female joint half strip; and
a removable bearing strip disposed in the annular groove, the bearing strip having a first end and a second end.

80. The firefighting equipment port of claim 79, wherein the female joint half further defines a tangential groove extending from the annular groove to an external port, whereby the bearing strip can be installed in the annular groove through the tangential groove.

81. The firefighting equipment port of claim 80, wherein the bearing strip second end comprises a hook, whereby the hook can be engaged by a tool to enable removal of the bearing strip from the annular groove through the tangential groove.

82. The firefighting equipment port of claim 79, wherein the bearing strip is sized to maintain a space between the male joint half and the female joint half.

83. The firefighting equipment port of claim 79, wherein the male and female joint halves further cooperate to define a second annular groove, and the rotatable fluid conduit joint further comprises a seal disposed in the second annular groove.

84. The fire fighting equipment port of claim 79, wherein the bearing strip and the annular groove each have a substantially diamond-shaped cross-section.

85. The firefighting equipment port of claim 79, wherein the bearing strip has substantially diamond-shaped cross-section, and has lateral corners that are rounded to relieve stress concentrations.

86. The firefighting equipment port of claim 79, wherein the female joint half is joined to a firefighting equipment connector.

87. The firefighting equipment port of claim 79, wherein the male joint half and the female joint half are free to rotate relative to one another.

88. A fluid conduit joint adapter, comprising:
a pair of female joint halves each defining a radially inwardly open channel, the female joint halves each being adapted to mate with a male joint half and define an annular groove when the radially inward open channel is disposed adjacent to a radially outward channel in a corresponding male joint half, and
a removable bearing strip disposed in each annular groove, the bearing strip having a first end and a second end, wherein the bearing strip second end comprises a hook, whereby the hook can be engaged by a tool to enable removal of the bearing strip from the annular groove.

89. The fluid conduit joint adapter of claim 88, wherein at least one of the female joint halves further defines a tangential groove extending from the annular groove to an external port, whereby the bearing strip can be installed in the annular groove through the tangential groove.

90. The fluid conduit joint adapter of claim 88, wherein the bearing strip is sized to maintain a space between the male joint half and the female joint half.

91. The fluid conduit joint adapter of claim 88, wherein the male and female joint halves further cooperate to define a second annular groove, and the rotatable fluid conduit joint further comprises a seal disposed in the second annular groove.

92. The fluid conduit joint adapter of claim 88, wherein the bearing strip and the annular groove each have a substantially diamond-shaped cross-section.

93. The fluid conduit joint adapter of claim 88, wherein the bearing strip has substantially diamond-shaped cross-section, and has lateral corners that are rounded to relieve stress concentrations.

94. The fluid conduit joint adapter of claim 88, wherein the female joint halves extend in substantially opposite directions from one another.

95. The fluid conduit joint adapter of claim 88, wherein the male joint half further defines a key-way and the joint further comprises a key disposed in the key-way to resist rotation of the male joint half relative to the female joint half strip.

96. The fluid conduit joint adapter of claim 88, wherein the male joint half and the female joint half are free to rotate relative to one another.

97. A fluid conduit joint adapter, comprising:
a pair of female joint halves each defining a radially inwardly open channel, the female joint halves each being adapted to mate with a male joint half and define an annular groove when the radially inward open channel is disposed adjacent to a radially outward channel in a corresponding male joint half; and
a removable bearing strip disposed in each annular groove, the bearing strip having a first end and a second end, and has a substantially diamond-shaped cross-section with lateral corners that are rounded to relieve stress concentrations.

98. The fluid conduit joint adapter of claim 97, wherein the female joint half further defines a tangential groove extending from the annular groove to an external port, whereby the bearing strip can be installed in the annular groove through the tangential groove.

99. The fluid conduit joint adapter of claim 98, wherein the bearing strip second end comprises a hook, whereby the hook can be engaged by a tool to enable removal of the bearing strip from the annular groove through the tangential groove.

100. The fluid conduit joint adapter of claim 97, wherein the bearing strip is sized to maintain a space between the male joint half and the female joint half.

101. The fluid conduit joint adapter of claim 97, wherein the male and female joint halves further cooperate to define a second annular groove, and the rotatable fluid conduit joint further comprises a seal disposed in the second annular groove.

102. The fluid conduit joint adapter of claim 97, wherein the bearing strip and the annular groove each have a substantially diamond-shaped cross-section.

103. The fluid conduit joint adapter of claim 97, wherein the female joint halves extend in substantially opposite directions from one another.

104. The fluid conduit joint adapter of claim 97, wherein the male joint half further defines a key-way and the joint further comprises a key disposed in the key-way to resist rotation of the male joint half relative to the female joint half strip.

105. The fluid conduit joint adapter of claim 97, wherein the male joint half and the female joint half are free to rotate relative to one another.

106. A fluid conduit joint adapter, comprising:
a pair of female joint halves each defining a radially inwardly open channel, the female joint halves each being adapted to mate with a male joint half and define an annular groove when the radially inward open channel is disposed adjacent to a radially outward channel in a corresponding male joint half;
a male joint half defining a radially outward open channel, the male joint half to mate with one of the female joint halves to define an annular groove, wherein the male joint half further defines a key-way and the joint further comprises a key disposed in the key-way to resist rotation of the male joint half relative to the female joint half strip; and
a removable bearing strip disposed in each annular groove, the bearing strip having a first end and a second end.

107. The fluid conduit joint adapter of claim 106, wherein at least one female joint half further defines a tangential groove extending from the annular groove to an external port, whereby the bearing strip can be installed in the annular groove through the tangential groove.

108. The fluid conduit joint adapter of claim 107, wherein the bearing strip second end comprises a hook, whereby the hook can be engaged by a tool to enable removal of the bearing strip from the annular groove through the tangential groove.

109. The fluid conduit joint adapter of claim 106, wherein the bearing strip is sized to maintain a space between the male joint half and the female joint half.

110. The fluid conduit joint adapter of claim 106, wherein the male half and at least one of the female joint halves further cooperate to define a second annular groove, and the rotatable fluid conduit joint further comprises a seal disposed in the second annular groove.

111. The fluid conduit joint adapter of claim 106, wherein the bearing strip and the annular groove each have a substantially diamond-shaped cross-section.

112. The fluid conduit joint adapter of claim 106, wherein the bearing strip has substantially diamond-shaped cross-section, and has lateral corners that are rounded to relieve stress concentrations.

113. The fluid conduit joint adapter of claim 106, wherein the female joint halves extend in substantially opposite directions from one another.
